(19) United States
(12) Patent Application Publication
(10) Pub. No.: US 2011/0173532 A1
(43) Pub. Date: Jul. 14, 2011

(54) GENERATING A LAYOUT OF TEXT LINE IMAGES IN A REFLOW AREA

(76) Inventors: George Forman, Port Orchard, WA (US); Prakash Reddy, Fremont, CA (US)

(21) Appl. No.: 12/687,059

(22) Filed: Jan. 13, 2010

(51) Int. Cl. G06F 17/21; G06K 9/34

(52) U.S. Cl. 715/256; 382/176

(57) ABSTRACT

A decomposition specification is received. The decomposition specification includes specifications of locations of text line images corresponding to complete lines of text in a document image. Based on the decomposition specification, a layout of the text line images in respective lines of a reflow area is generated, where each of the lines of the reflow area has a respective maximum line length. In this process, successive ones of the text line images are packed onto the lines of the reflow area with divisions of one or more of the text line images into respective portions that are concatenated with text image content of other ones of the text line images to fill respective ones of the lines of the reflow area without exceeding the respective maximum line lengths.

### BACKGROUND

Document reflow involves reestablishing where the line breaks and page breaks occur in a text document. Document reflowing happens as a matter of course in any word processor or web browser when the size of the character font or the page margins/dimensions are changed. This capability requires an online representation of the elements of the text. The ability to reflow images of texts is important in a number of circumstances. Foremost is the growing business of repurposing scanned images of books for electronic reader devices (e.g., desktop computers, and mobile devices, such as specialized electronic book (eBook) devices, laptops, mini-notebook “net-books,” and other mobile devices, including mobile telephones), in which the display area is smaller than a typical book page. Rather than requiring the user to scroll horizontally on each line to read the full width of the page—which is completely impractical for usability—the text needs to be reflowed to fit the narrower page of the device. After the reflowing, a user simply needs to scroll vertically to read through the reformatted book. Other purposes include reformatting a scanned text for printing with a larger font size, reproducing a scanned book with a large font in a smaller font, reprinting a book with a different page size than the original, and using excerpts of a scanned text within a poster or other document in a way that calls for line breaks different than in the original.

When an image of text needs to be reflowed, optical character recognition (OCR) typically is performed on the scanned text to produce a character stream representation of the scanned text that can be reflowed. This approach has the disadvantage that errors in the OCR results will appear in the reflowed text. In another approach, the location of each word in each block of text is determined utilizing page decomposition software that provides a location, height and width of the bounding box for each word, and the text data is reflowed by taking each successive bounding box for each word and generating a line of text until each line is filled and, if the bounding box of a word extends beyond the display width, a new line is started and the word is placed on the new line. By requiring the identification of each word in a scanned document, this approach is computationally and memory resource intensive, making it less suitable for compact application environments in which processing and memory resources typically are significantly constrained.

### DESCRIPTION OF DRAWINGS

FIG. 1 is a block diagram of an example embodiment of a document reflow system that reflows text line images in a document image in a reflow area.

FIG. 2 is a flow diagram of an example embodiment of a method of decomposing a document image.

FIG. 3 is a diagrammatic view of an example text block and an associated set of bounding boxes of text line images in the text block.

FIG. 4 is a flow diagram of an example embodiment of a method of reflowing text line images.

FIG. 5 is a flow diagram of an example embodiment of a method of reflowing text line images.

FIG. 6 is a diagrammatic view of an example document image and a reflow area containing reflowed text line images extracted from the document image.

FIG. 7 is a diagrammatic view of an example document image and a reflow area containing reflowed text line images extracted from the document image.

FIG. 8 is a block diagram of an example embodiment of a computer system that implements an embodiment of the document reflow system of FIG. 1.

### DETAILED DESCRIPTION

In the following description, like reference numbers are used to identify like elements. Furthermore, the drawings are intended to illustrate major features of example embodiments in a diagrammatic manner. The drawings are not intended to depict every feature of actual embodiments nor relative dimensions of the depicted elements, and are not drawn to scale.

### I. DEFINITION OF TERMS

A “computer” is any machine, device, or apparatus that processes data. Some types of computers process data according to computer-readable instructions that are stored on a computer-readable medium either temporarily or permanently. Example types of computers include server, desktop and portable computers, electronic book readers, personal digital assistants (PDAs), multimedia players, game controllers, mobile telephones, and pagers), image and video recording and playback devices (e.g., digital still and video cameras, VCRs, and DVRs), printers, and other embedded data processing environments (e.g., application-specific integrated circuits (ASICs)).

The term “reflow area” refers to an area where text can be displayed, including areas of a display screen and areas of a printed page.

The terms “text” and “textual” refer to a logical arrangement of text elements (e.g., glyphs, characters, or symbols) of a written composition or a score of a musical composition. Text may or may not be presented with divisions between logical aggregates (e.g., words, sentences, or musical bars) of the constituent text elements.

A “text line image” is an image of a line of text. A “line of text” refers to a sequential arrangement of text elements, typically in reading order, along a line that may be straight or curved. The term “maximum line length” refers to the maximum potential length of a respective reflow area line that is available for displaying one or more whole or partial text line images. The maximum line lengths of different lines of a reflow area may be the same or different.

### II. INTRODUCTION

The embodiments that are described herein provide document reflow apparatus and methods that can reflow text written in flowing script type languages (e.g., Hindi) and non-word-based texts (e.g., music), without requiring significant memory and computational resources. At least some of these embodiments do not require the use of OCR engines or the like in order to reflow text and therefore are not limited to reflowing text for which OCR engines are available. Due to their efficient use of processing and memory resources, some of these embodiments may be implemented in relatively small and inexpensive components that have modest processing power and modest memory capacity. As a result, these embodiments are highly suitable for incorporation into compact computer device environments that have significant size, processing, and memory constraints, including but not limited to an mobile devices (e.g., electronic book readers, portable computers, personal digital assistants (PDAs), multimedia players, game controllers, mobile telephones, and pagers), image and video recording and playback devices (e.g., digital still and video cameras, VCRs, and DVRs), printers, and other embedded data processing environments (e.g., application specific integrated circuits (ASICs)).

### III. REFLOWING A DOCUMENT

A. Overview

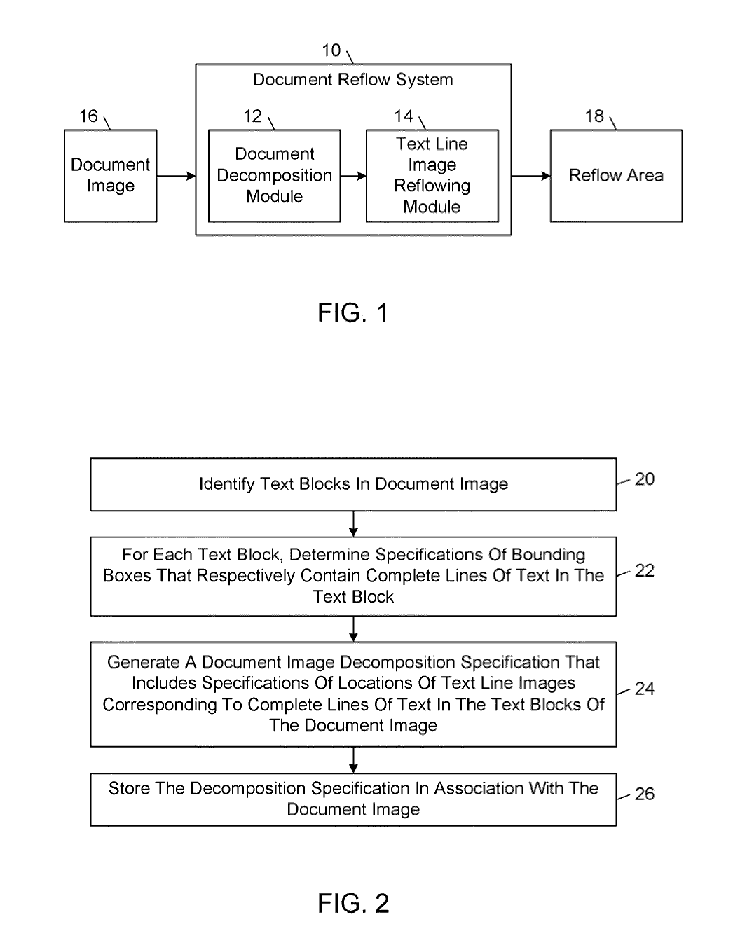

FIG. 1 shows an embodiment of a document reflow system 10 that includes a document decomposition module 12 and a text line image reflowing module 14. In operation, the document reflow system 10 reflows text lines images in a document image 16 into a reflow area 18 such that the reflow area 18 contains images of the same textual content reflowed to at least one different line width. The document decomposition module 12 decomposes the document image 16 to produce a decomposition specification that includes specifications of locations of text line images corresponding to complete lines of text in the document image 16. Based on the document image decomposition specification, the text line image reflowing module 14 reflows the text line images by packing successive ones of the text line images onto the lines of the reflow area 18 with divisions of one or more of the text line images into respective portions that are concatenated with text image content of other ones of the text line images to fill respective ones of the lines of the reflow area 18 without exceeding a specified output line width. In the reflow process, when they fit, entire text lines are packed onto lines of the reflow area 18 without segmenting the text lines into respective portions (e.g., at word boundaries).

The document image 16 may be any type of image that contains one or more lines of text (e.g., a scanned image of a printed page of text). The reflow area 18 may be any type of area where images of lines of text may be displayed, including a computer display screen and a printed page.

Embodiments of the document reflow system 10 may be implemented by one or more discrete modules (or data processing components) that are not limited to any particular hardware, firmware, or software configuration. In the illustrated embodiments, these modules may be implemented in any type of computer environment, including in digital electronic circuitry (e.g., an application-specific integrated circuit, such as a digital signal processor (DSP)) or in computer hardware, firmware, device driver, or software. In some embodiments, the functionalities of the modules of the document reflow system 10 are combined into a single data processing component. In some embodiments, the respective functionalities of each of one or more of the modules of the document reflow system 10 are performed by a respective set of multiple data processing components.

The document decomposition module 12 and the text line image reflowing module 14 may be co-located on a single apparatus or they may be distributed across multiple apparatus. If distributed across multiple apparatus, document decomposition module 12 and the text line image reflowing module 14 may communicate with each other over local wired or wireless connections, or they may communicate over global network connections (e.g., over the Internet). In some example embodiments, the document decomposition module 12 is located on a server computer and the text line image reflowing module 14 is located on a client computer terminal (e.g., a desktop computer or a portable computer, such as an eBook reader or a mobile telephone).

B. Decomposing A Document Image

The document decomposition module 12 decomposes the document image 16 to produce a decomposition specification that includes specifications of locations of text line images corresponding to complete lines of text in the document image 16 (see FIG. 1).

FIG. 2 shows a method by which the document decomposition module 12 decomposes the document image 16.

In accordance with the method of FIG. 2, the document decomposition module 12 identifies text blocks in the document image 16 (FIG. 2, block 20). For each text block, the document decomposition module 12 determines specifications of bounding boxes that respectively contain complete lines of text in the text block (FIG. 2, block 22). In some embodiments, each bounding box corresponds to the smallest rectangle with vertical and horizontal sides that encompasses a complete line of text in a text block. The document decomposition module 12 generates a document image decomposition specification that includes specifications of locations of the determined text images corresponding to the complete lines of text in the text blocks of the document image (FIG. 2, block 24). The document decomposition module 12 stores the document image decomposition specification in association with the document image 16 (FIG. 2, block 26).

In some embodiments, the decomposition specification is in the form of a data structure (e.g., a table or a list) that is stored on a computer-readable medium in an XML (eXtensible Markup Language) file format. The decomposition specification may be associated with the document image 16 in a variety of different ways. For example, in some embodiments, the decomposition specification may be incorporated into a metadata header of the document image data file. In other embodiments, the decomposition specification may be stored in a separate data file that includes a reference (e.g., a hyperlink or a uniform resource locator) to the document image 16.

In some embodiments, the document decomposition module 12 identifies text blocks in the document image 16 and determines specifications of bounding boxes that respectively contain complete lines of text in the text block using any of a variety of different document decomposition processes that commonly are used in optical character recognition technology. Such processes typically include image binarization and text segmentation. The binarization process typically involves classifying image pixels as text or background based on adaptive thresholding and histogram analysis. The text segmentation process typically involves using connected components analysis or edge-based analysis to identify regions of text in the binarized image.

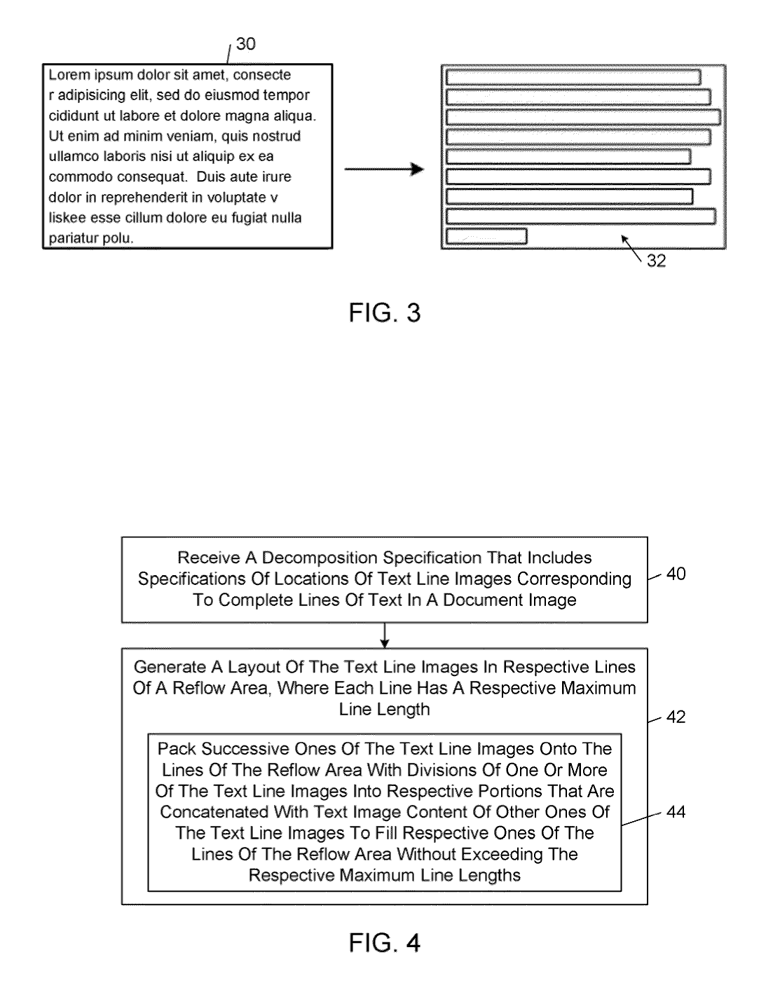

FIG. 3 shows an example text block 30 that has been decomposed by the document decomposition module 12 into a set of text line bounding boxes 32 representing the locations of the determined text line images corresponding to the complete lines of text in the text block 30. The locations of the text line images in the document image decomposition specification may be specified in a variety of ways. In some embodiments, the coordinates of the upper left and lower right corners of each text line bounding box are used to specify the location of the corresponding text line image.

C. Reflowing Text Line Images

The text line image reflowing module 14 reflows the text line images specified in the document decomposition specification received from the document decomposition module 12 in the reflow area 18 (see FIG. 1).

FIG. 4 shows an embodiment of a method by which the text line image reflowing module 14 reflows text lines images in the document image 16 into the reflow area 18.

In accordance with the method of FIG. 4, the text line image reflowing module 14 receives the decomposition specification from the document decomposition module (FIG. 2, block 40). The text line image reflowing module 14 generates a layout of the text line images in respective lines of a reflow area, where each of the lines of the reflow area has a respective maximum line length. In this process, the text line image reflowing module 14 packs successive ones of the text line images onto the lines of the reflow area with divisions of one or more of the text line images into respective portions that are concatenated with text image content of other ones of the text line images to fill respective ones of the lines of the reflow area without exceeding the respective maximum line lengths (FIG. 4, block 44).

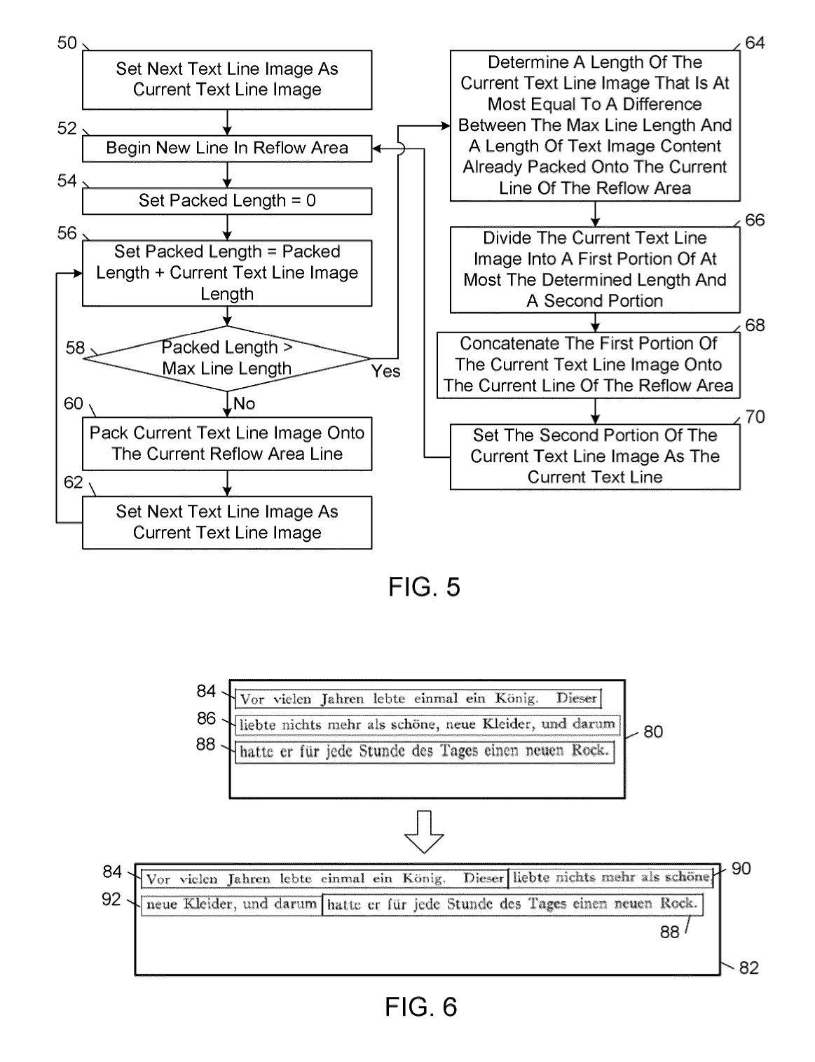

FIG. 5 shows an example embodiment by which the text line image reflowing module 14 packs successive ones of the text line images onto the lines of the reflow area.

In accordance with the method of FIG. 5, the text line image reflowing module 14 sets a next text line image in the document image as the current text line image (FIG. 5, block 50). When the process starts for a given text block of the document image, the next text line image is the first text line image in the current text block. The text line image reflowing module 14 begins a new line in the reflow area (FIG. 5, block 52).

The text line image reflowing module 14 sets the packed length for the current line of the reflow area equal to zero (FIG. 5, block 54). The text line image reflowing module 14 sets the packed length equal to the sum of the previous packed length and the length of the current text line image (FIG. 5, block 56).

If the packed length is not greater than the maximum line length specified for the current reflow area line (FIG. 5, block 58), the text line image reflowing module 14 packs the current text line image onto the current reflow area line (FIG. 5, block 60), sets the next text line image in the document image as the current text line image (FIG. 5, block 62), and repeats the line packing process (FIG. 5, blocks 56-62).

If the packed length is greater than the maximum line length specified for the current reflow area line (FIG. 5, block 58), the text line image reflowing module 14 determines a length of the current text line image that is at most equal to a difference between the maximum line length and a length of text image content already packed onto the current line of the reflow area (FIG. 5, block 64). The text line image reflowing module 14 divides the current text line image into a first portion consisting of a first part of the current text line image having a length equal to the determined length and a second portion consisting of the remainder of the current text line image (FIG. 5, block 66). The text line image reflowing module 14 concatenates the first portion of the current text line image onto the current line of the reflow area (FIG. 5, block 68). The text line image reflowing module 14 sets the second portion of the current text line image as the current text line (FIG. 5, block 70) and repeats the process for a new line in the reflow area (FIG. 5, block 52).

When the packed length exceeds the maximum line length specified for the current line of the reflow area (FIG. 5, block 58), the text line image reflowing module 14 divides the current text line image into a suitable length that does not exceed the specified maximum line length (FIG. 5, block 64). In some embodiments, the text line image reflowing module 14 selects a division location that does not divide logical aggregates of textual glyphs in the one or more text line images. In these embodiments, the text line image reflowing module 14 determines a division location of a selected text line image that is outside a logical aggregate of textual elements (e.g., words or musical bars) in the selected text line image. In some of these embodiments, the text line image reflowing module 14 detects one or more divisional locations between logical aggregates in the selected text line image and selects a respective one of the division locations that maximizes a concatenated length the first portion of the selected text line image and the text image content already packed onto the current line of the reflow area without exceeding the maximum line length. In this process, the text line image reflow module 14 searches for the division location in a limited portion of the text line image to be divided near the maximal division location, which corresponds to the location that demarcates a portion of the text line image having a length equal to the difference between the maximum line length of the current reflow area line being packed and the length of text image content already packed onto the current reflow area line. The text line image reflowing module 14 searches from the maximal division location in reverse reading order and selects the first division location found (which corresponds to the logical aggregate boundary closest to the maximal division location) as the division location.

With respect to textual content that is written in accordance with an orthography (e.g., an orthography of a language using an alphabetic script) that includes discernable breaks (e.g., in English or German orthographies, words are separated by space marks) between words, the text line image reflowing module 14 searches for the first such break starting at the maximal division location and moving toward the beginning of the current text line image in reverse reading order.

FIG. 6 shows an example document image 80 and a reflow area 82 containing reflowed text line images extracted from the document image 80. In this example, the document image 80 contains textual content that is written in a language (i.e., German) that uses an alphabetic script in which space marks separate words. The textual content of the document image 80 is presented in the form of a first text line image 84, a second text line image 86, and a third text line image 88. In the process of reflowing the text line images 84-88 in the reflow area 82, the text line image reflowing module 14 packs the first text line image 84 onto the first line in the reflow area. The text line image reflowing module 14 divides the second text line image 86 into a first portion 90 and a second portion 92 at the space between the first comma and the word “neue.” The text line image reflowing module 14 concatenates the first portion 90 with the first text line image 84 onto the first line of the reflow area 82. The text line image reflowing module 14 packs the second portion 92 of the second text line image 86 onto the second line of the reflow area 82. The text line image reflowing module 14 packs the third text line image 86 of the document image 80 with the second portion 92 of the second text line image onto the second image of the reflow area 82.

An approach similar to the one used to detect boundaries between words written in languages using alphabetic scripts is used for reflowing document images of musical compositions. In some embodiments, the text line image reflowing module 14 reflows text line images of a musical composition based on the detection of bar lines between the measures of the musical composition. In these embodiments, the text line image reflowing module 14 selects any needed division locations in such text line images at bar lines separating bars of the musical composition.

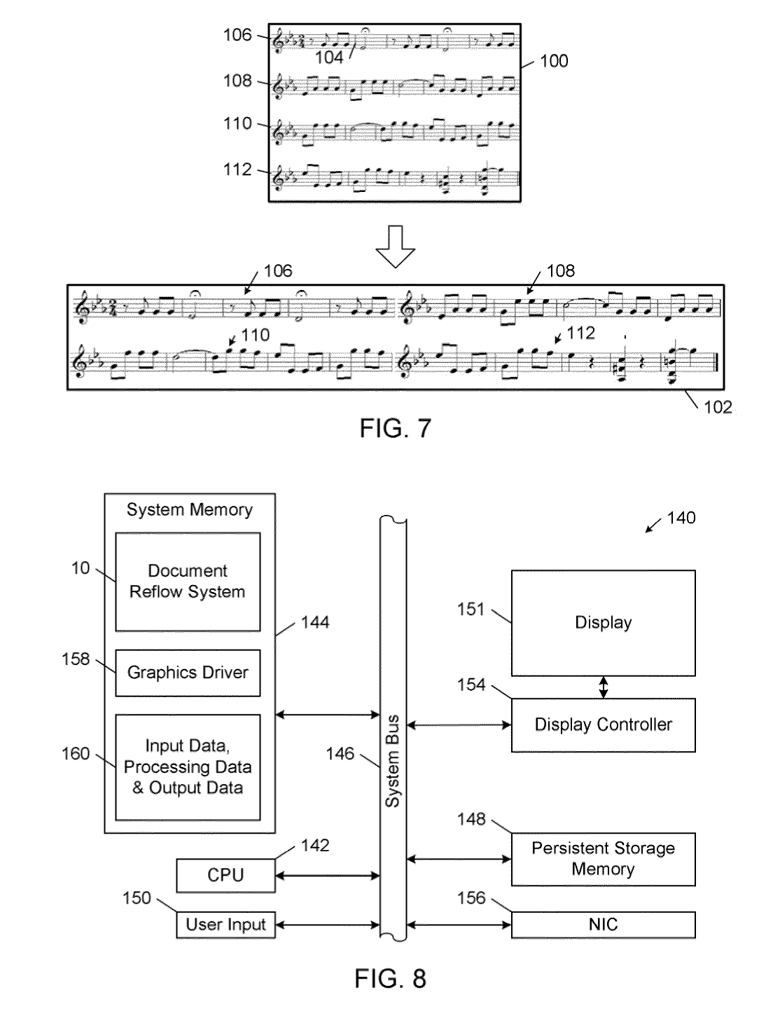

FIG. 7 shows an example document image 100 and a reflow area 102 containing reflowed text line images extracted from the document image 100. In this example, the document image 100 contains textual content corresponding to a musical composition in which bar lines 104 demarcate respective boundaries between the bars of the musical composition. In the process of reflowing the four text line images 106, 108, 110, 112 of the document image 100, the text line image reflowing module 14 packs the first and second text line images 106, 108 onto the first line of the reflow area 102, and packs the third and fourth text line images 110, 112 onto the second line of the reflow area 102.

With respect to textual content written in accordance with an orthography that does not include discernable breaks between words, the text line image reflowing module 14 may determine the division location in the current text line image based on an analysis of the textual content (FIG. 5, block 66). As explained above, in this process the text line image reflowing module 14 need only search a limited portion of the text line image to be divided for a word boundary rather than search for all word boundaries. For example, Chinese and Hindi are written without spaces between words. In some embodiments, the text line image reflowing module 14 searches for boundaries between words written in such languages based on a dictionary or a spelling corrector process (see, e.g., “Chinese Word Tutorial,” by Alias-i, Inc. available from http://alias-i.com/lingpipe/demos/tutorial/chineseTokens/read-me.html, and Veena Bansal, M. K. Sinha, “A Complete OCR for Printed Hindi Text in Devanagari Script,” icdar, pp. 0800, Sixth International Conference on Document Analysis and Recognition (ICDAR'01), 2001). In this process, the text line image reflowing module 14 determines the maximal division location in the current text line image, which corresponds to a location that demarcates a portion of the text line image having a length equal to the difference between the maximum line length and a length of text image content already packed onto the current line of the reflow area being packed, and then searches for a word boundary in the current text line image starting from the maximal division location and moving toward the beginning of the current text line image in reverse reading order. The text line image reflowing module 14 selects the first word boundary found (which corresponds to the word boundary closest to the maximal division location) as the division location.

### IV. EXAMPLE OPERATING ENVIRONMENTS

In general, the document reflow system 10 typically includes one or more discrete data processing components, each of which may be in the form of any one of various commercially available data processing chips. In some implementations, the document reflow system 10 is embedded in the hardware of any one of a wide variety of digital and analog computer devices, including desktop and workstation computers, digital still image cameras, digital video cameras, printers, scanners, and portable electronic devices (e.g., mobile phones, laptop and notebook computers, and personal digital assistants). In some embodiments, the document reflow system 10 executes process instructions (e.g., machine-readable code, such as computer software) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

FIG. 8 shows an embodiment of a computer system 140 that can implement any of the embodiments of the document reflow system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer system 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 8, the system memory 144 also stores the document reflow system 10, a graphics driver 158, and processing information 160 that includes input data, processing data, and output data. In some embodiments, the document reflow system 10 interfaces with the graphics driver 158 (e.g., via a DirectX® component of a Microsoft Windows® operating system) to present a user interface on the display 151 for managing and controlling the operation of the document reflow system 10.

### V. CONCLUSION

The embodiments that are described herein provide document reflow apparatus and methods that can reflow text written in flowing script type languages (e.g., Hindi) and non-word-based texts (e.g., music), without requiring significant memory and computational resources. Due to their efficient use of processing and memory resources, some of these embodiments may be implemented in relatively small and inexpensive components that have modest processing power and modest memory capacity. As a result, these embodiments are highly suitable for incorporation into compact computer device environments that have significant size, processing, and memory constraints.

Other embodiments are within the scope of the claims.

1. A method, comprising:
receiving a decomposition specification comprising specifications of locations of text line images corresponding to complete lines of text in a document image; and
generating by a computer a layout of the text line images in respective lines of a reflow area, wherein each of the lines of the reflow area has a respective maximum line length, and the generating comprises packing successive ones of the text line images onto the lines of the reflow area with divisions of one or more of the text line images into respective portions that are concatenated with text image content of other ones of the text line images to fill respective ones of the lines of the reflow area without exceeding the respective maximum line lengths.

2. The method of claim 1, wherein the packing comprises selecting a current one of the of the text line images for packing onto a current one of the lines of the reflow area, and concatenating at least a portion of the selected text line image onto the current line of the reflow area in response to a determination that a combined length of the at least a portion of the selected text line image and text image content already packed onto the current line is at most equal to the respective maximum line length.

3. The method of claim 1, wherein the packing comprises:
selecting a current one of the text line images for packing onto a current one of the lines of the reflow area;
determining a length of the selected text line image that is at most equal to a difference between the respective maximum line length and a length of text image content already packed onto the current line;
dividing the selected text line image into a first portion of at most the determined length and a second portion; and
concatenating the first portion of the selected text line image onto the current line of the reflow area.

4. The method of claim 3, wherein the packing further comprises selecting the second portion of the text line image for packing onto a successive one of the lines of the reflow area.

5. The method of claim 1, wherein the packing comprises dividing the one or more of the text line images into the respective divisions without dividing logical aggregates of textual elements in the one or more text line images.

6. The method of claim 5, wherein the dividing comprises determining a division location that demarcates a portion of a selected one of the one or more text line images having a length that is less than a difference between the respective maximum line length and a length of text image content already packed onto a current one of the lines of the reflow area being packed and is outside a logical aggregate of textual elements in the selected text line image, and dividing the selected text line image at the division location into a first portion to be packed onto the current line of the reflow area and a second portion.

7. The method of claim 6, wherein the determining comprises searching for the division location in reverse reading order from a maximal division location that demarcates a section of the selected text line image having a length equal to the difference between the respective maximum line length and the length of text image content already packed onto the current line of the reflow area being packed.

8. The method of claim 6, wherein the determining comprises selecting the division location between words in the selected text line image.

9. The method of claim 8, wherein the selecting comprises detecting one or more divisional locations between words in the selected text line image and selecting a respective one of the division locations that maximizes a concatenated length the first portion of the selected text line image and the text image content already packed onto the current line of the reflow area without exceeding the respective maximum line length.

10. The method of claim 6, wherein the determining comprises selecting the division location at a bar line separating bars of a musical composition in the selected text line image.

11. Apparatus, comprising:
a computer-readable medium storing computer-readable instructions; and
a processor coupled to the computer-readable medium, operable to execute the instructions, and based at least in part on the execution of the instructions operable to perform operations comprising
receiving a decomposition specification comprising specifications of locations of text line images corresponding to complete lines of text in a document image; and
based on the decomposition specification, generating a layout of the text line images in respective lines of a reflow area, wherein each of the lines of the reflow area has a respective maximum line length, and the generating comprises packing successive ones of the text line images onto the lines of the reflow area with divisions of one or more of the text line images into respective portions that are concatenated with text image content of other ones of the text line images to fill respective ones of the lines of the reflow area without exceeding the respective maximum line lengths.

12. The apparatus of claim 11, wherein in the packing the processor is operable to perform operations comprising:
selecting a current one of the text line images for packing onto a current one of the lines of the reflow area;
determining a length of the selected text line image that is at most equal to a difference between the respective maximum line length and a length of text image content already packed onto the current line;
dividing the selected text line image into a first portion of at most the determined length and a second portion; and
concatenating the first portion of the selected text line image onto the current line of the reflow area.

13. The apparatus of claim 11, wherein in the packing the processor is operable to perform operations comprising dividing the one or more of the text line images into the respective divisions without dividing logical aggregates of textual elements in the one or more text line images.

14. The apparatus of claim 13, wherein in the dividing the processor is operable to perform operations comprising determining a division location that demarcates a portion of a selected one of the one or more text line images having a length that is less than a difference between the respective maximum line length and a length of text image content already packed onto a current one of the lines of the reflow area being packed and is outside a logical aggregate of textual elements in the selected text line image, and dividing the selected text line image at the division location into a first portion to be packed onto the current line of the reflow area and a second portion.

15. The apparatus of claim 14, wherein in the determining the processor is operable to perform operations comprising searching for the division location in reverse reading order from a maximal division location that demarcates a section of the selected text line image having a length equal to the difference between the respective maximum line length and the length of text image content already packed onto the current line of the reflow area being packed.

16. At least one computer-readable medium having computer-readable program code embodied therein, the computer-readable program code adapted to be executed by a computer to implement a method comprising:
receiving a decomposition specification comprising specifications of locations of text line images corresponding to complete lines of text in a document image; and
based on the decomposition specification, generating a layout of the text line images in respective lines of a reflow area, wherein each of the lines of the reflow area has a respective maximum line length, and the generating comprises packing successive ones of the text line images onto the lines of the reflow area with divisions of one or more of the text line images into respective portions that are concatenated with text image content of other ones of the text line images to fill respective ones of the lines of the reflow area without exceeding the respective maximum line lengths.

17. The at least one computer-readable medium of claim 16, wherein the packing comprises:
selecting a current one of the text line images for packing onto a current one of the lines of the reflow area;
determining a length of the selected text line image that is at most equal to a difference between the respective maximum line length and a length of text image content already packed onto the current line;
dividing the selected text line image into a first portion of at most the determined length and a second portion; and
concatenating the first portion of the selected text line image onto the current line of the reflow area.

18. The at least one computer-readable medium of claim 16, wherein the packing comprises dividing the one or more of the text line images into the respective divisions without dividing logical aggregates of textual elements in the one or more text line images.

19. The at least one computer-readable medium of claim 18, wherein the dividing comprises determining a division location that demarcates a portion of a selected one of the one or more text line images having a length that is less than a difference between the respective maximum line length and a length of text image content already packed onto a current one of the lines of the reflow area being packed and is outside a logical aggregate of textual elements in the selected text line image, and dividing the selected text line image at the division location into a first portion to be packed onto the current line of the reflow area and a second portion.

20. The at least one computer-readable medium of claim 19, wherein the determining comprises searching for the division location in reverse reading order from a maximal division location that demarcates a section of the selected text line image having a length equal to the difference between the respective maximum line length and the length of text image content already packed onto the current line of the reflow area being packed.
